(19) United States
(12) Patent Application Publication
(10) Pub. No.: US 2011/0148141 A1
(43) Pub. Date: Jun. 23, 2011

(54) MOTOR VEHICLE WITH A ROOF ARRANGEMENT

(75) Inventors: KURT PFERTNER, Friolzheim (DE); WOLFGANG DITTRICH, Bietigheim-Bissingen (DE)

(73) Assignee: Dr. Ing. h.c. F. Porsche Aktiengesellschaft, Stuttgart (DE)

(21) Appl. No.: 12/983,467

(22) Filed: Jan. 3, 2011

Related U.S. Application Data
(63) Continuation-in-part of application No. 12/384,800, filed on Apr. 9, 2009, now abandoned.

(30) Foreign Application Priority Data
Apr. 12, 2008 (DE) 10 2008 018 577.9

(51) Int. Cl. B60J 7/04; B60J 9/00

(52) U.S. Cl. 296/180.3

(57) ABSTRACT

A motor vehicle with a roof arrangement and a spoiler lying behind the roof arrangement, whereby the roof arrangement has at least one movable roof element, which is adjustable between a closed position and an open position. The roof element is automatically adjustable in the direction of the closed position starting from its open position for achieving a defined, presettable aerodynamic effect at the spoiler.

### CROSS REFERENCE TO RELATED APPLICATIONS

This application is a continuation-in-part application of U.S. patent application Ser. No. 12/384,800 filed Apr. 9, 2009, which claims priority to German Patent Application No. DE 10 2008 018 577.9, filed Apr. 12, 2008, the contents of such applications being incorporated by reference herein in their entirety.

### FIELD OF THE INVENTION

This invention relates to a motor vehicle having a roof arrangement.

### BACKGROUND OF THE INVENTION

A motor vehicle has become known from the class-forming DE 101 38 027 A1, which is incorporated by reference herein. It has a roof arrangement, which has at least one movable roof element, such that a roof opening of the motor vehicle can be released at least partly, when the roof element is adjusted into an open position. The roof opening is closed when the roof element occupies a closed position. An aerodynamic spoiler is embodied behind the roof arrangement in the form of a so-called roof spoiler. In order to achieve various aerodynamic effects, the roof spoiler can be shifted, opened up more or less wide and assume various setting angles depending on the driving speed and/or the position of the roof.

### SUMMARY OF THE INVENTION

An object of the present invention is to provide a motor vehicle of the type mentioned in the introduction, in which the comfort and performance of the motor vehicle are optimized.

The advantages mainly achieved with the present invention can be seen in that due to the automatic movement of the roof element in the closing direction, the air flow guided over the roof arrangement during the travel of the vehicle can flow largely undisturbed up to the spoiler, as a result of which this spoiler, in an especially preferred embodiment, can exhibit an especially favorable aerodynamic effect. In an especially preferred embodiment, this defined, presettable effect will be a maximum achievable output force, such that a corresponding pressure on the roadway may take place especially in the area of the rear axle of the motor vehicle, which may be especially the driven axle.

According to an especially preferred exemplary embodiment not only is the roof element of the roof arrangement adjustable, but also the spoiler, which, according to this, can be moved between a withdrawn inoperative position and an aerodynamically effective extended position. Provisions may especially be made for this that the spoiler is moved between the inoperative position and the extended position depending on the driving speed. It is advantageous when the spoiler is able to occupy various extended positions of varying aerodynamic effect. Preferably, this takes place continuously, such that an optimal adaptation of the spoiler to desired driving properties of the motor vehicle is possible.

According to another preferred exemplary embodiment, the spoiler can be moved between the withdrawn inoperative position and the aerodynamically effective extended position depending on the position of the sliding roof. Thus, in some adjustment ranges, the effect of the open sliding roof can be compensated by adjusting the spoiler, so that an as optimal as possible aerodynamic effect can be achieved. However, in some cases, which may be associated, e.g., even with higher driving safety, the roof element is—as described above—moved in the direction of the closed position, preferably in a fully closed position, so that the spoiler is able to operate optimally.

Especially preferably, a roof arrangement of this type will contain a sliding roof, which is designed as slidable over a roof membrane, which can be designed, for example, as fixed, for the open position. In other words, in a preferred embodiment, the roof arrangement is a so-called outside-guided or outside-running sliding roof.

The present invention is explained in detail below based on an exemplary embodiment with reference to the drawing.

### BRIEF DESCRIPTION OF THE DRAWINGS

FIGS. 1 through 3 show partial lateral views of a motor vehicle, in which a roof arrangement and a spoiler can occupy different positions.

FIG. 4 shows a block diagram depicting the interrelationship between the components of the vehicle that interact together to control the moveable roof element and the spoiler of the motor vehicle.

FIG. 5 shows a flow diagram depicting the automatically initiated closing process of the roof element.

### DETAILED DESCRIPTION OF THE DRAWINGS

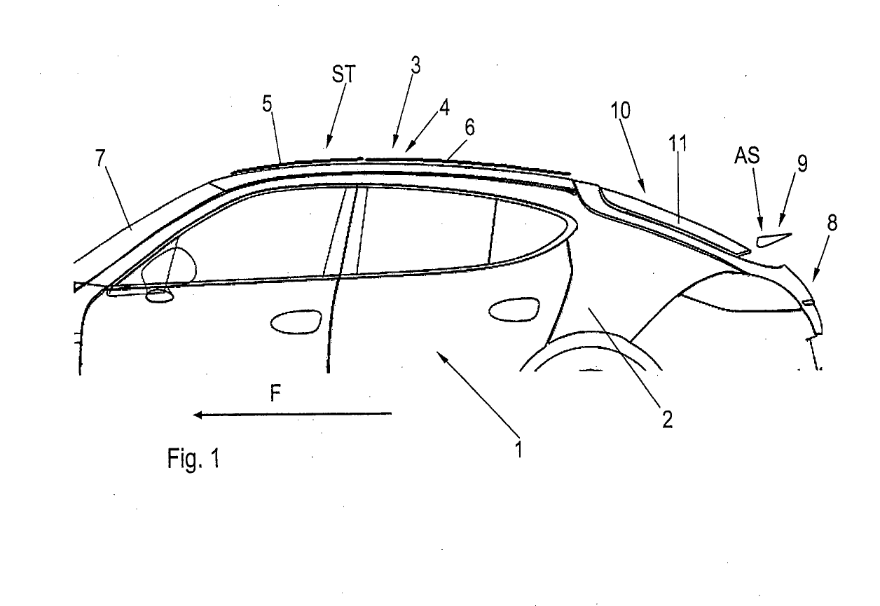

In FIG. 1 can be seen a motor vehicle 1, which has a body 2, which, besides other body parts not described in detail, also has a vehicle roof 3. Into the vehicle roof 3 is inserted a roof arrangement 4, which has at least one linear movable roof element 5 and a preferably fixed, i.e., unmovable, roof membrane 6 arranged behind it. The roof element 5, to which the roof membrane 6 is connected, is inserted after a windshield 7. This applies in relation to a vehicle front not shown here and a vehicle rear 8 of the body 2. Between the vehicle rear 8 and the roof arrangement 4 is arranged a spoiler 9

The spoiler 9 is arranged on a rear cover 10 of the body 2, which carriers a rear window 11 between the spoiler 9 and the roof arrangement 4. It can be seen that a body line inclined from the roof arrangement 4 in the direction of the rear 8 is present, in which the spoiler 9 lies beneath the level of the roof arrangement. Otherwise, the spoiler 9 lies—in relation to the vehicle front—behind the roof arrangement 4 and forms a rear-side spoiler 9.

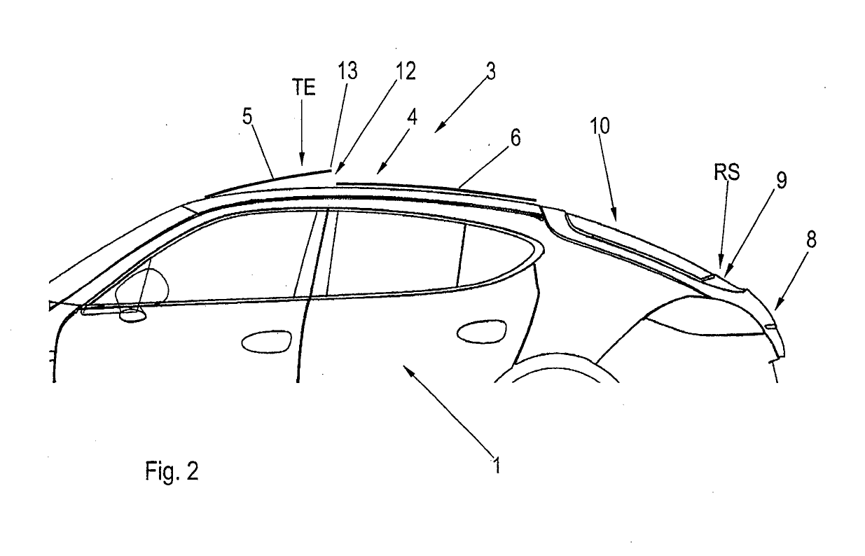

The spoiler 9 is shown in an aerodynamically effective extended position AS in FIG. 1. A withdrawn inoperative position RS of the spoiler 9 can be seen in FIG. 2. The spoiler 9 is also adjustable to various extended positions that are located between the extended position AS and the inoperative position RS.

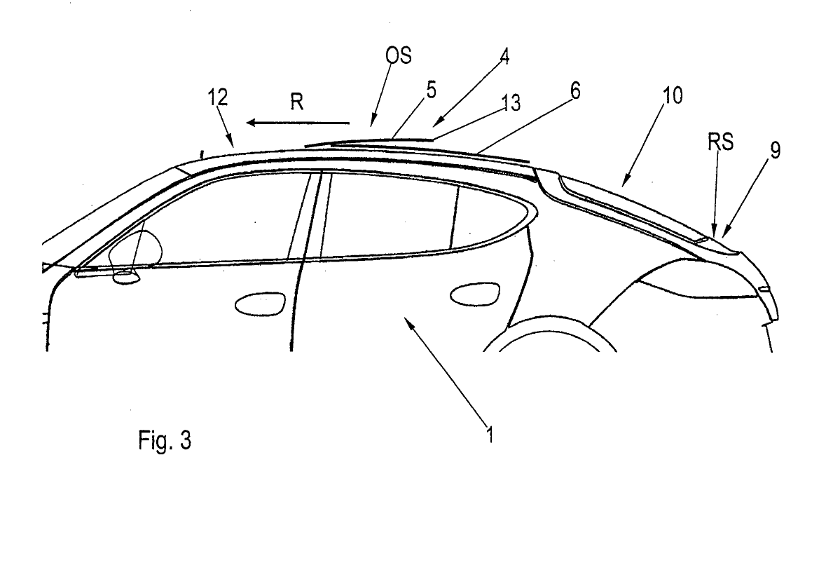

The at least one roof element 5 of the roof arrangement is shown in FIG. 1 in a closed position ST, in which a roof opening 12 (FIGS. 2 and 3) is completely closed. By aligning at least its rear edge 13, the roof element 5 can be shifted over the roof membrane 6 by subsequent linear displacement, so that the roof element 5—starting from its partly open position TE shown in FIG. 2 with raised rear edge 13 can be moved into an open position OS, which can be seen in FIG. 3 and in which the roof opening 12 is at least partly released. The roof element 5 can occupy any partly open position between the closed position ST and the open position OS.

Especially in that the roof element 5 comes to lie in the open position OS above the roof membrane 6 and/or above the rear cover 10, an air flow guided over the vehicle roof 3 during the travel (arrow F) of the vehicle 1 is influenced, such that the air flow does not optimally flow against the spoiler 9 located in the extended position AS under the circumstances. To prevent this, according to aspects of the present invention, the roof element 5 of the roof arrangement 4, which is especially designed as a sliding roof, can move, especially in a special driving situation, from its open position OS in the direction R of the closed position ST, when the spoiler 9 shall exhibit a defined, presettable aerodynamic effect.

Preferably, provisions are made that the roof element 5 is brought into the fully closed position ST in which the roof opening 12 is closed. Driving situations of this type may occur, for example, when the motor vehicle 1 is driven in the so-called limit range. This may be achieved intentionally or unintentionally by the driver of the motor vehicle. It would be conceivable as well, however, especially in a desirable, sporty adjustment of the motor vehicle, which includes, for example, changes in the adjustable chassis, motor parameters or the like, for the roof element 5 to be moved automatically in the direction R of the closed position ST, when this defined sportiness is activated. Activations of this type have become known as so-called sport mode, in which different vehicle properties can be adjusted in the direction of sporty or comfortable.

Preferably, the roof element 5 is moved in the direction of the closed position ST when the spoiler 9 shall deliver a maximum achievable aerodynamic effect, such as, for example, a maximum producible output force. For this, it is necessary for the above-mentioned air flow to be able to flow essentially as unaffected as possible up to the spoiler 9 in the extended position AS. It would also be conceivable, however, for the spoiler to be designed as fixed, such that it occupies the extended position AS constantly. Nevertheless, in certain driving situations, the roof element 5 can be moved in the direction R of the closed position ST in order to be able to achieve an optimal aerodynamic effectiveness with a fixed spoiler.

For the closing of the roof element 5 according to the present invention, it would additionally be conceivable for the spoiler 9 to be adjusted in different extended positions AS between the withdrawn inoperative position RS and the maximum extended position AS shown depending on the position of the roof element 5 in order for the spoiler 9 to exhibit an optimized aerodynamic effect in case of an open roof arrangement 4.

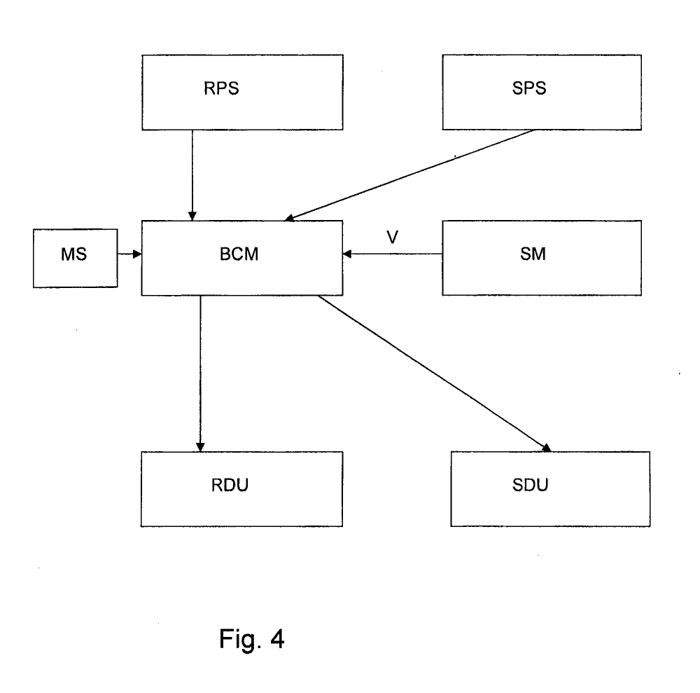

FIG. 4 shows a block diagram depicting the interrelationship between the components of the motor vehicle that facilitate movement of the moveable roof element 5 and the spoiler 9. According to FIG. 4, a body computer (control) module (BCM) of the vehicle assumes control of the central functions of the motor vehicle, such as, for example, lights, window defogger, windshield wipers, taillights, etc. The BCM is also operatively connected to a spoiler drive unit (SDU) and a roof drive unit (RDU) to control those components. The SDU is operatively connected to the spoiler 9 to move the spoiler 9. The RDU is operatively connected to roof element 5 to move the roof element 5. The BCM receives signals from a user-operated mode switch (MS), as will be described later. The BCM also receives a vehicle speed ‘V’ signal from a stability module SM control device (electronic stability control unit) of the motor vehicle. The vehicle speed ‘V’ signal is representative of the speed of the motor vehicle.

The spoiler drive unit (SDU) is operatively connected to the BCM and spoiler 9. The SDU is an electrical drive unit in particular, such as for example, a linear drive or motor. Details of a spoiler drive unit are disclosed in U.S. patent application Ser. No. 12/466,734, which is incorporated by reference herein.

Based upon the value of the vehicle speed ‘V’ signal received from the stability module (SM) control device, the BCM energizes the SDU to move spoiler 9 between the two positions AS and RS. In particular, when the vehicle speed ‘V’ value ‘X’ reaches a predetermined value, for example 120 km/h, the BCM energizes the SDU to move spoiler 9 from the retracted position RS into the extended position AS. Once the vehicle speed ‘V’ value ‘X’ falls below a predetermined value, for example 80 km/h, the BCM energizes the SDU to return the spoiler 9 to the retracted position RS.

A spoiler position sensor (SPS) is operatively connected to the BCM, as well as the spoiler 9 and/or the spoiler drive unit (SDU). The SPS senses the position of the spoiler 9, and communicates that position (in the form of an electrical signal) to the BCM. Based upon the characteristics of that signal, the BCM determines whether the spoiler 9 is in a retracted position RS or an extended position AS. The SPS may be a Hall sensor or a mechanical limit switch that detects at least one position of the spoiler (e.g., AS or RS) or both positions AS and RS of the spoiler 9. If a stationary spoiler 9 is provided on the vehicle, the SPS and the SDU may be omitted.

The roof drive unit (RDU) is operatively connected to the BCM and roof element 5 to move the roof element between an open position and a closed position ST. The RDU is an electrical drive unit in particular, such as for example, a linear drive or motor. Details of a roof drive unit are disclosed in U.S. Pat. No. 5,941,598, which is incorporated by reference herein.

A roof position sensor (RPS) is operatively connected to the BCM, as well as the roof element 5 and/or the RDU. The RPS communicates the position of the roof element 5 (in the form of an electrical signal) to the BCM. Based upon the characteristics of that signal, the BCM determines whether the roof element 5 is in the closed position ST or the open position. The RPS may be a Hall sensor or a mechanical limit switch that detects the closed position ST of the roof element 5.

A user-operated switch (not shown) is provided on the vehicle for opening and closing the roof element 5. In operation, when the user contacts the user-operated switch, the BCM activates the roof drive unit (RDU) which moves the roof element 5 between a closed position ST and an open position. The user-operated switch differs from the mode switch (MS).

The BCM also receives signals from a user-operated mode switch (MS) that is provided in the motor vehicle. The mode switch (MS) is used to change one or more characteristics, settings or configurations of the motor vehicle. According to one exemplary embodiment, the mode switch is a switch for activating a high-performance mode (i.e., a ‘Sport’ mode) of the motor vehicle. As is known to those skilled in the art, upon activating a Sport mode (i.e., by selecting a sport button) of a motor vehicle, one or more electronic control units transmit signals to different components of the motor vehicle to adjust operation of those components (e.g., stiffen the suspension, adjust the steering, and/or adjust the transmission shift points). U.S. Pat. Nos. 7,678,005; 7,603,924; 7,426,916; 7,402,119; 7,349,776; 7,286,919; 7,252,345; 6,800,387; 6,470,771; 6,346,064; 6,304,809; 6,295,500; and 5,425,686, discuss the operation of a ‘sport mode’, each of which are incorporated by reference herein.

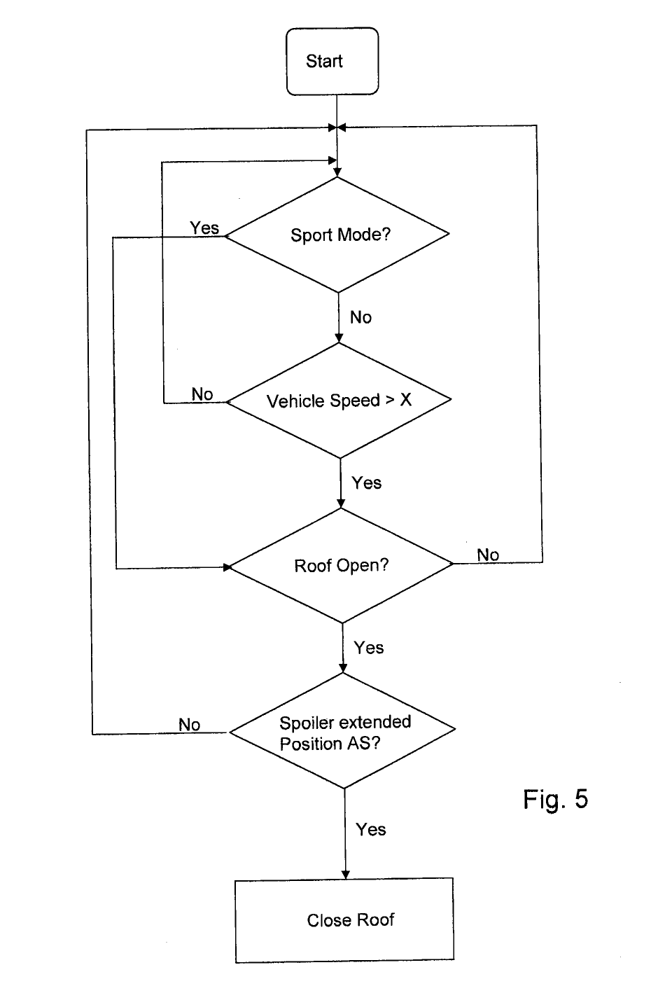

As will be described with reference to FIG. 5 hereinafter, according to one exemplary embodiment of the invention, the BCM is configured to move the roof element 5 as a function of the position of spoiler 9, and other variables, to achieve a pre-defined aerodynamic effect at the spoiler 9. More particularly, the BCM controls the RDU (which controls the position of the roof element 5) as a function of signals received from the RPS, the SPS, the mode switch (MS), and the stability module (SM) control device.

FIG. 5 shows a flow diagram depicting the automatically initiated closing process of the roof element 5. Instructions for following the automatically initiated closing process are archived in a corresponding computer program in the BCM. The BCM commences operations as soon as the motor vehicle 1 starts up. Once the vehicle is started, an initial query is made as to whether the mode switch MS has been activated, thus switching the motor vehicle into a ‘Sport’ mode if the mode switch has been activated.

As shown in the flow diagram of FIG. 5, the BCM is configured to energize the RDU to automatically move a roof element 5 to the closed position ST if the following conditions are met, namely: (a) the mode switch has been activated (as sensed by the BCM); (b) the roof element 5 is open (as sensed by the RPS and communicated to the BCM); and (c) the spoiler 9 is deployed to an open position AS (as sensed by the SPS and communicated to the BCM). If, however, the roof element 5 is already set to a closed position ST or the spoiler 9 is not deployed to an open position AS, then the process returns to the ‘Start’ step.

The BCM is also configured to energize the RDU to automatically move an open roof element 5 to the closed position ST if the following conditions are met, namely: (a) the mode switch (MS) has not been activated (as sensed by the BCM); (b) the speed ‘V’ of the motor vehicle has exceeded a predetermined value ‘X’, for example, 120 km/h (as communicated to the BCM by the SM control device); (c) the roof element 5 is set to an open position OS (as sensed by the RPS and communicated to the BCM); and (d) the spoiler 9 is deployed to an open position AS (as sensed by the SPS and communicated to the BCM). If, however, the roof element 5 is already set to a closed position ST, the speed ‘V’ of the motor vehicle has not exceeded the predetermined value ‘X’, or the spoiler 9 is not deployed to an open position AS, then the process returns to the ‘Start’ step.

According to another exemplary embodiment of the invention, the BCM is configured to move the spoiler 9 toward the retracted position RS as a function of the position of roof element 5, and other variables, to achieve a pre-defined aerodynamic effect at the spoiler 9. More particularly, the BCM is configured to energize the SDU to automatically move a spoiler 9 toward the extended positioned AS if the following conditions are met, namely: (a) the mode switch has been activated (as sensed by the BCM); (b) the roof element 5 is at least partially open (as sensed by the RPS and communicated to the BCM); and (c) the speed ‘V’ of the motor vehicle has exceeded a predetermined value ‘X’, for example, 120 km/h (as communicated to the BCM by the SM control device).

The spoiler 9 is adjustable between various extended positions that are each located between the retracted position RS and the extended position AS depending on the position of the sliding roof 5. For example, if the sliding roof 5 is located approximately midway between positions OS and ST, then the BCM extends the spoiler 9 to a position that is approximately midway between AS and RS.

While preferred embodiments of the invention have been described herein, it will be understood that such embodiments are provided by way of example only. Numerous variations, changes and substitutions will occur to those skilled in the art without departing from the spirit of the invention. It is intended that the appended claims cover all such variations as fall within the spirit and scope of the invention.

What is claimed:

1. Motor vehicle comprising:
a roof arrangement has a sliding roof that is adjustable between a closed position and an open position;
a spoiler positioned at a location behind the roof arrangement; and
a switch for activating a high-performance mode of the motor vehicle,
wherein, upon activating the switch of the motor vehicle, the sliding roof is automatically adjustable in a direction toward the closed position starting from an open position once a predetermined speed of the motor vehicle is reached to achieve a defined aerodynamic effect at the spoiler.

2. Motor vehicle in accordance with claim 1, wherein the aerodynamic effect results in an application of pressure unto a roadway in an area of a driven axle of the motor vehicle.

3. Motor vehicle in accordance with claim 1, wherein the spoiler is adjustable between a withdrawn inoperative position and an extended position.

4. Motor vehicle in accordance with claim 1, wherein the spoiler is adjustable between various extended positions depending on the position of the sliding roof.

5. Motor vehicle in accordance with claim 1, wherein the spoiler is adjustable depending on the position of the sliding roof.

6. Motor vehicle in accordance with claim 1, wherein the sliding roof is slidable over a fixed roof membrane to the open position.

7. Motor vehicle in accordance with claim 1, wherein the sliding roof is automatically adjustable to reach the closed position to achieve a predetermined aerodynamic effect at the spoiler at a high velocity of the vehicle.

8. Motor vehicle in accordance with claim 1, wherein the spoiler is arranged on a rear cover of a body of the vehicle.

9. Motor vehicle in accordance with claim 8, wherein the rear cover carries a rear window between the spoiler and the roof arrangement.

10. Motor vehicle in accordance with claim 1, wherein a body line of the vehicle is inclined from the roof arrangement in a direction of a rear end of the vehicle.

11. Motor vehicle in accordance with claim 1, wherein the spoiler is positioned at an elevation that is below an elevation of the roof arrangement.

12. A motor vehicle comprising:
a roof arrangement having a sliding roof that is adjustable between a closed position and an open position; and
a spoiler that is configured in an extended position and positioned at a location behind the roof arrangement,
wherein, upon activating a particular setting of the motor vehicle, the sliding roof is automatically adjustable in a direction toward the closed position starting from an open position at a predetermined speed of the motor vehicle to achieve a defined aerodynamic effect at the spoiler which is configured in an extended position.

13. A method of operating a sliding roof of a motor vehicle comprising the step of automatically moving the sliding roof from an open position to a closed position when the motor vehicle exceeds a predetermined speed and a spoiler of the vehicle is configured in an extended position to achieve a defined aerodynamic effect at the spoiler.
